(19) United States
(12) Patent Application Publication
(10) Pub. No.: US 2012/0182293 A1
(43) Pub. Date: Jul. 19, 2012

(54) METHOD AND ARRANGEMENT FOR GENERATING REPRESENTATIONS OF ANISOTROPIC PROPERTIES AND A CORRESPONDING COMPUTER PROGRAM AND A CORRESPONDING COMPUTER-READABLE STORAGE MEDIUM

(75) Inventor: Gert Nolze, Berlin (DE)

(73) Assignee: BRUKER NANO GMBH, Berlin (DE)

(21) Appl. No.: 13/384,643

(22) PCT Filed: Jun. 12, 2010
(86) PCT No.: PCT/EP2010/059964

§ 371 Date: Apr. 5, 2012

(30) Foreign Application Priority Data
Jul. 22, 2009 (DE) 10 2009 027 940.7

(51) Int. Cl. G06T 15/04; G06T 11/00

(52) U.S. Cl. 345/419; 345/585

(57) ABSTRACT

A method and an arrangement for generating representations of anisotropic properties as well as a related computer program and a related machine-readable storage medium are provided, for use in material science for representing textures, or in diffractometry, for example for quickly generating stereographic or gnomonic projections of anisotropic properties (pole figures, orientation density distributions, EBSD [Electron Backscatter Diffraction] patterns or the like). For this purpose, in the method for generating representations of anisotropic properties, it is proposed to carry out the following steps: determining a radial distribution of at least one anisotropic property; generating a sphere or polyhedron model, the surface of which respectively includes at least partly a reproduction of the radial distribution; generating the representations of anisotropic properties by projection of at least a part of the radial distribution reproduced on the sphere or polyhedron surface into a plane using a computer graphics program.

Method and arrangement for generating representations of anisotropic properties as well as a related computer program and a related machine-readable storage medium

The invention relates to a method and an arrangement for generating representations of anisotropic properties as well as a related computer program and a related machine-readable storage medium, which can be used in particular in material science for representing textures, or in diffractometry, for example for quickly generating stereographic or gnomonic projections of anisotropic properties (pole figures, orientation density distributions, EBSD [Electron Backscatter Diffraction] patterns or the like).

In material science, orientation distribution of crystals in a polycrystalline solid is often represented by means of stereographic projection. A simple area of application are pole figures which visualize radial orientation of surfaces in 3-dimensional space. To obtain pole figures for one crystal, the latter is placed in the centre of a virtual projection sphere. For the actual projection of crystal faces one uses the respective face normals, that is to say, for each face the straight line which is a) perpendicular to it and b) at the same time, passes through the centre of the sphere. The face normals are extended so that they cut the surface of the projection sphere. These points of intersection are described as poles (or surface poles) and serve as projection points. In stereographic projection, all poles are projected from the South Pole of the projection sphere (the projections centre) onto a plane which passes tangentially through the North Pole of the projection sphere. The straight line passing through the projection centre (South Pole) and the centre of the sphere (and thus also through the North Pole) equally defines the normal of the projection surface.

For polycrystalline materials, pole figures are not only created for one crystal, but are generated for a multitude of crystals or measured crystal orientations of the examined body. This may be hundreds of thousands or millions, which involves a corresponding amount of effort in the calculation of the pole figures.

For the better understanding of a material property it is often necessary and desirable to rotate that distribution of points in the space, which amounts to a real rotation of hundreds of thousands of crystals of different orientation. Usually, this means to generate again and again pole figures from different projection centres, i.e. the crystals virtually arranged in the centre of the projection sphere are viewed again and again from different viewing directions. Conventionally, for this purpose, the calculation steps of stereographic projection are carried out anew for all poles form the new projection centre. For pole figures which image a multitude of crystals this means an enormous calculation effort, which makes a so called real time rotation virtually impossible.

The object of the invention is precisely to provide a method and an arrangement for generating representations of anisotropic properties (e.g. orientation distributions, pole figures, EBSD patterns of crystalline materials) as well as a related computer program and a related machine-readable storage medium, which prevent the disadvantages of known solutions and in particular permit an improved visualization of these properties.

The object is achieved according to the invention through the features in the characterizing part of claims 1, 18, and 20 through 22 in interaction with the features in the preamble. Advantageous embodiments of the invention are contained in the subclaims.

A special advantage of the method according to the invention is that even the representations of anisotropic properties (e.g. of the density distribution of the surface poles described above) for various projection centres can be generated very quickly. This is achieved by determining the radial distribution of the anisotropic properties of at least one crystal in a first step in the method for generating representations of anisotropic properties. The examined anisotropic, i.e. directionally dependent, properties of crystals may concern in particular the pole figures already mentioned, but also orientation density distributions, EBSD patterns or the like, and this list is not to be understood as exhaustive.

Therein, the at least one crystal is arranged in the centre of the virtual projection sphere, the distinctive feature being that the projection surface is defined by the spherical surface. Therein, as mentioned, the poles of the at least one crystal are represented by the points of intersection of the surface normals of the at least one crystals with the spherical surface. As a result, one obtains the arrangement of the poles on the spherical surface, which amounts to a radial arrangement or distribution of the poles and shall also hereinafter be described as such. By analogy, a radially emitted diffraction pattern (e.g. the patterns in the EBSD method, starry sky) may also be mapped to the projection sphere.

According to the invention, in a next step, a sphere model, e.g. a virtual sphere, is generated in a computer and the surface of the sphere model is provided with a representation of the radial distribution of the anisotropic property. In this case, the representation of the radial distribution of the anisotropic property is present in the form of machine-readable image data, which represent a sphere model, the surface of which includes a reproduction of the radial distribution of the anisotropic property. Therein, the whole surface can show a reproduction of the radial distribution, or it may be intended that only a part of the surface reproduces the representation of the radial distribution of the anisotropic property.

In an alternative embodiment of the invention, the radial distribution of the anisotropic property is calculated for several plane projection surfaces (usefully for the surfaces of a polyhedron, e.g. a cube) and transformed into machine-readable image data, for example into data of a raster graphics image or a bitmap. These machine-readable image data are subsequently suitably projected onto the 3D model of a spherical surface. Preferably, this is done in the form of a so called texture mapping.

Subsequently, the stereographic or gnomonic representation of the anisotropic property—for example the pole figure—is generated by suitably mapping the spherical surface provided with the pattern of the radial distribution of the anisotropic property. According to the invention, a graphics program, preferably a standard graphics software, is used for generating representations of anisotropic properties. Therein, it is intended that generating the representation of the at least one anisotropic property, e.g. by several bitmaps, occurs by means of a graphics program. Preferably, however, a graphics program is also used for generating the sphere model or mapping the image data to the inner spherical surface. The use of a graphics program offers the advantage of having recourse to a number of special functions of computer graphics and/or to special graphics hardware. In particular, it proves to be advantageous if functions or functionalities of a graphics card can be used. This means that the method for visualizing anisotropic properties is very much accelerated. Thus, a quick, almost undelayed representation in particular of the stereographic or gnomonic projection of anisotropic properties, such as pole figures for representing textures in material science, is possible in real time.

Generally, for generating stereographic or gnomonic projection using a graphics software, it is intended in a preferred embodiment that the pattern of the radial distribution of an anisotropic property (e.g. pole figures, orientation density distributions, EBSD patterns . . . ) reproduced on a projection sphere or mapped to the projection sphere is projected onto a projection surface from a projection centre. In the present case, the pole figure or other representations of radial distributions of anisotropic properties are generated using a graphics program by using the frustum of a virtual camera depending on its position to map the spherical surface provided with the pattern of the radial distribution of an anisotropic property in a distorted manner, so that it corresponds to a stereographic or gnomonic projection. Therein, the camera represents the projection centre, which is used in the classical sense for generating a stereographic or gnomonic projection. For this purpose, the projection centre or position of the virtual camera and virtual sphere are arranged in a virtual space in a computer. In a preferred embodiment, the projection surface is defined by the plane which is located perpendicular to the viewing direction of the camera, tangential to the projection sphere, i.e. passes through the North Pole of the sphere. For a person skilled in the art of computer graphics it is clear how the graphical structures for defining the objects in virtual space, such as projection centre or virtual camera and virtual sphere, have to be chosen. Therein, the viewing direction of the virtual camera is defined by the South Pole and centre of the virtual sphere, wherein a representation appearing non-centred may still be realized (free choice of section) by determining a non-centric frustum maintaining the viewing direction. The pattern of the asymmetric distribution of the property to be represented, which is mapped as a bitmap to the virtual surface of the sphere, is recorded by the virtual camera in a distorted manner by this projection. A stereographic projection of the pattern of the radial distribution of the anisotropic property mapped to the inside of the virtual sphere surface is obtained if the virtual camera is directly on the surface of the sphere, with the viewing direction towards the centre of the sphere formed by the spherical surface (in accordance with the construction principles of stereographic projection). Thus, the position of the camera always defines the South Pole of the projection sphere. The gnomonic projection of the identical scene is easily obtained by shifting the position of the camera from the outer diameter of the virtual sphere into its centre maintaining the viewing direction. By defining the position of the camera on the spherical surface and thus also the orientation of the viewing direction of the virtual camera (the fix point in stereographic projection is the centre of the sphere, i.e. the viewing direction of the camera in stereographic projection is always radial) it is determined which area of the virtual space is represented on an image output device such as a monitor or display of a computer. As a result of the described arrangement of the objects in virtual space, by choosing the frustum of the virtual camera, it is always a part of the projection of the anisotropic property that is represented on the image output device.

According to the invention, at least a visualization of the spherical surface provided with the texture, e.g. by a bitmap, is realized by functions of a computer graphics program. Preferably, however, also the machine-readable image data, the virtual camera, and the virtual sphere are realized as objects in a computer graphics program, preferably in a standard computer graphics program such as OpenGL or DirectX.

An arrangement according to the invention includes at least one chip and/or processor and is adapted in such a way that a method for generating the anisotropic property (e.g. pole figure, orientation density distribution, EBSD patterns . . . ) to be represented can be carried out, wherein the following steps are carried out:
determining a radial distribution of at least one anisotropic property,
generating a sphere model, the surface of which at least partly maps the radial distribution of a property,
generating the representations of anisotropic properties by projection of at least a part of the machine-readable image data mapped to the spherical surface into the plane using a computer graphics program.

A computer program according to the invention enables a data processing device to carry out a method for generating a radial, asymmetric distribution of a property after having been loaded into the memory of the data processing device, wherein the method comprises the following steps:
determining a radial distribution of at least one anisotropic property,
generating a sphere model, the surface of which at least partly includes a reproduction of the radial distribution,
generating the representations of anisotropic properties by projection of at least a part of the machine-readable image data mapped on the surface of the sphere into the plane using a computer graphics program.

In a further preferred embodiment of the invention, it is intended that the computer program according to the invention has a modular structure, wherein individual modules are installed on different data processing devices.

Preferred embodiments provide additional computer programs which enable further method steps or method processes as stated in the description to be carried out.

Such computer programs may for example be provided (against a fee or free of charge, freely available or password-protected) downloadable in a data or communication network. The computer programs so provided may then be utilized by a method in which a computer program according to claim 20 is then downloaded from an electronic data network such as the Internet, on a data processing device connected to the data network.

To carry out the method according to the invention for generating and representing 3-dimensional, anisotropic properties, it is intended to use a machine-readable storage medium on which a program is stored that enables a data processing device to carry out a method for generating and representing radial, anisotropic properties after having been loaded into the memory of the data processing device, wherein the method comprises the following steps:
determining a radial distribution of at least one anisotropic property,
generating a sphere model, the surface of which at least partly includes a reproduction of the radial distribution,
generating the representations of anisotropic properties by projection of at least a part of the machine-readable image data mapped to the spherical surface into the plane using a computer graphics program.

In the case of gnomonic projection, the sphere model, the projection sphere, or the spherical surface may be replaced by a polygon model, a projection polygon, or a polygon surface in above embodiments.

Since, in models generated in a computer, no distinction is made between internal and external faces in different cases, embodiments of the invention are possible in which the representations of anisotropic properties generally occur on the face or surface of the sphere or polyhedron model.

The invention is hereinafter explained in more detail with reference to the figures of the drawing using an exemplary embodiment (property: pole figure) in which:

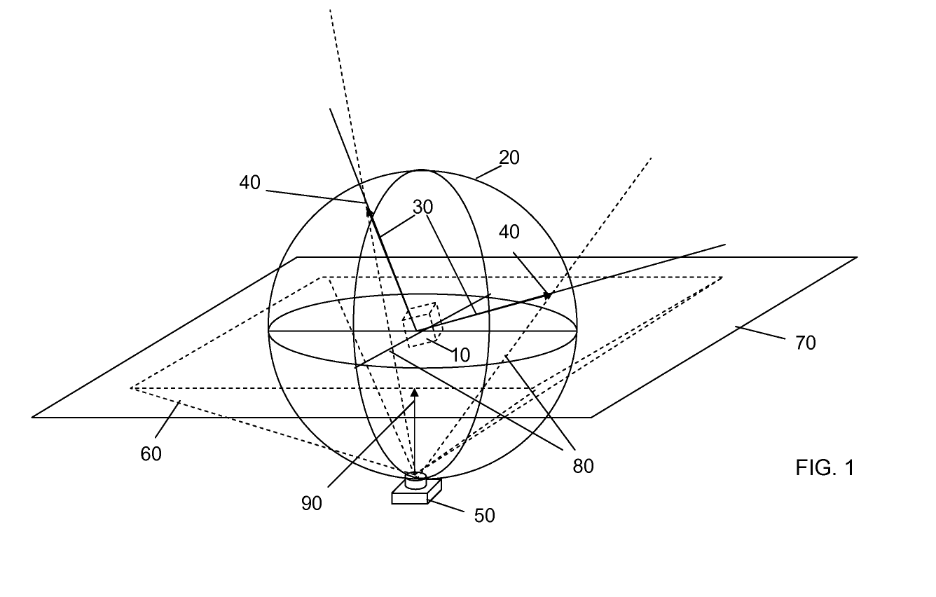

FIG. 1 shows an illustration of generating a stereographic projection using the example of a pole figure by means of a virtual camera; and

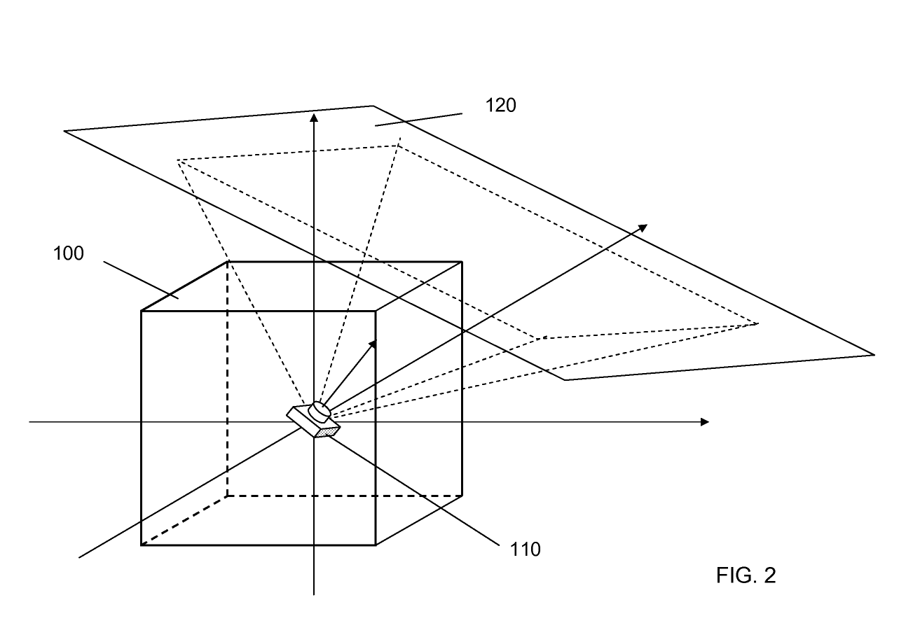

FIG. 2 shows an illustration of a gnomonic projection using a cube as projection polygon.

Although the exemplary embodiment is explained in more detail using the example of the poles figures, the invention is not limited to generating representations of that anisotropic property. The invention rather enables further other directionally dependent properties, such as orientation distributions density, EBSD patterns or the like, to be represented and visualized in a comparable manner. Beyond that, further projections besides stereographic and gnomonic projection can be used for mapping the radial distribution of the anisotropic properties in the plane.

A requirement for the representation of pole figures is the calculation of the radial distribution of the poles on the projection sphere 20. For this purpose, for a number of differently oriented crystals 10—that can be a single one, but also several millions—which are all virtually arranged in the centre of the projection sphere 20 and of which selected surface normals 30 (directions in reciprocal space) or crystal directions are considered for each crystal, which shall be hereinafter generally described as vectors. The points of intersection of the vectors 30 with the surface of the projection sphere 20 represent the poles (penetration points) 40. The radial distribution of the poles 40 results form crystal orientations and is determined by a one-time calculation.

The result of this calculation, i.e. the radial distribution of the poles of all examined crystals 10 on the surface of the projection sphere 20, is either calculated on the sphere surface, or e.g. alternatively stored as a graph in an image file, for example as a pattern in a bitmap.

For representing, a virtual scene which at least comprises the 3D model of a projection sphere 20 and a virtual camera 50 is defined in a computer. This virtual scene is defined by means of a graphics program such as OpenGL. For this purpose, OpenGL provides a multitude of functions. Thus, the virtual 3D scene can be generated in a simple way.

Subsequently, the property is projected onto the surface of the projection sphere 20, i.e. e.g. covered with the bitmap as surface texture. In one embodiment, a special OpenGL function can be used for this projection. In an alternative direct calculation of the property on the sphere surface, the texture mapping of a bitmap is omitted.

Further, the position, viewing direction 90 (orientation), frustum 60, and other parameters of the virtual camera 50 are defined by means of the functions provided by the graphics program. In a special embodiment, the parameters are predetermined in such a way that the virtual camera 50 looks from the South Pole of the projection sphere 20 over the centre of the projection sphere 20 on the bitmap projected onto the sphere surface. The so defined appearance of the bitmap from the point of view of the virtual camera corresponds exactly to the definition of the stereographic projection.

In this case, the virtual camera 50 represents in the classical sense the projection centre for the stereographic projection by which the property is mapped to the surface of the projection sphere 20, i.e. by the arrangement of the objects of virtual camera 50 and projection sphere 20, which is e.g. provided with the pattern of the radial distribution of the poles, the representation of the radial distribution of the poles mapped to the projection sphere 20 is mapped, so that it becomes visible as a pole FIG. 80. By varying the frustum (opening angle), virtually any area of the pole figure may be represented with any magnification, which may be effected by the graphics program on any means of visual data output such as a monitor, display or the like.

If it is now necessary to view the pole figure from another projection centre, it is sufficient, when using the invention, to redefine the position, viewing direction 90 (orientation), frustum 60 and the like of the virtual camera 50, or else to rotate the projection sphere 20 with the texture mapped to it in an appropriate manner. For these operations, graphics programs such as OpenGl or DirecX provide special functions by which the operations are performed in real time or substantially in real time. This quick performance is achieved by the fact that, on the one hand, the information (distribution of the asymmetric property) has not to be permanently recalculated, and that, on the other hand, the graphics programs communicate directly with a graphics card and a multitude of operations, such as coordinate transformations, projections, scaling or the like, are performed clearly faster by the hardware of the graphics card. A permanent recalculation of the stereographic projection by software, as it happens conventionally, is prevented by the invention.

If one shifts the position of the camera 50 into the centre of the projection sphere 20 and again maps the texture mapped to the sphere surface, one obtains, only through this change of position, the gnomonic projection as it appears on a plane projection screen of an area detector (e.g. of a EBSD detector) instead of the stereographic one.

The gnomonic projection may also be generated by means of specially adapted bit-maps—e.g. calculated for a cube 100—if one moves the camera 110 to the point for which the bitmaps were calculated. Since the calculation of the bitmaps on plane surfaces proves to be particularly simple, gnomonic projections can so be generated in a particularly simple way. For this purpose, any polyhedron may be used, the cube 100 certainly being the most simple one. If the calculation of the projection occurs from the cube centre on a projection surface 120, and if all six faces of the cube 100 are calculated and composed successively, one obtains for each orientation a gnomonic projection of the calculated bitmap even when rotating the cube 100 around its centre if the camera 110 is seated exactly in the centre of the cube 100 (that is analogous to the sphere already described because it represents in the mathematical sense a polyhedron with an indefinite number of faces).

The embodiments of the invention are not limited to the preferred exemplary embodiments mentioned above. There is rather a number of variants conceivable which makes use of the arrangement and method according to the invention even in case of fundamentally different embodiments.

### LIST OF REFERENCE NUMERALS

10 crystals
20 projection sphere
30 surface normal
40 pole
50 virtual camera
60 frustum
70 projection surface
80 pole figure
90 viewing direction
100 cube
110 camera
120 projection surface

1. A method for generating representations of anisotropic properties, comprising the steps of:
determining a radial distribution of at least one anisotropic property,
generating a sphere or polyhedron model, the surface of which respectively includes at least partly a reproduction of the radial distribution,
generating the representations of anisotropic properties by projection of at least a part of the radial distribution reproduced on the sphere or polyhedron surface into a plane using a computer graphics program.

2. The method according to claim 1,
wherein
the representations of anisotropic properties comprise at least
one pole figure,
one orientation distribution density, or
one EBSD pattern.

3. The method according to claim 1,
wherein
the radial distribution reproduced on the surface of the sphere model is projected into the plane by stereographic or gnomonic projection.

4. The method according to claim 1,
wherein
the radial distribution reproduced on the surface of the polyhedron model is projected into the plane by gnomonic projection.

5. The method according to claim 1, wherein
the representation of anisotropic properties is generated by
defining a sphere or polyhedron surface in a virtual space in a computer, wherein the sphere or polyhedron surface respectively includes at least partly the reproduction of the radial distribution, and
the representations of anisotropic properties are generated as projection of the reproduction of the radial distribution mapped to the sphere or polyhedron surface on a projection surface (70, 120) starting from a predetermined projection centre.

6. The method according to claim 5,
wherein
the projection centre is located
on the spherical surface,
on the polyhedron surface,
in the centre of the sphere, or
in the centre of the polyhedron.

7. The method according to claim 5,
wherein
the projection centre is the centre of a central projection.

8. The method according to claim 1, wherein
the representation of anisotropic properties is generated by
defining a spherical surface in a virtual space in a computer, wherein the spherical surface includes at least partly the reproduction of the radial distribution,
arranging a virtual camera (50) in the centre of the sphere or at a provided position on the spherical surface in such a way that the optical axis of the virtual camera (50) passes through the centre of the sphere, and
mapping the representation of anisotropic properties as a projection of the spherical surface to a virtual projection surface (70), which tangentially touches the spherical surface.

9. The method according to claim 1, wherein
the representation of anisotropic properties is generated by
defining a polyhedron surface in a virtual space in a computer, wherein the polyhedron surface includes at least partly the reproduction of the radial distribution,
arranging a virtual camera (110) in the centre of the polyhedrons, and
mapping the representation of anisotropic properties as a projection of the polyhedron surface to a virtual projection surface (120), which is orthogonally oriented to the optical axis of the virtual camera (110).

10. The method according to claim 1, wherein
a computer graphics program is used for mapping the machine-readable image data to the spherical or polyhedron surface.

11. The method according to claim 1, wherein
the computer graphics program is a 3D graphics programming interface (Application Programming Interface=API) such as OpenGL or DirecX.

12. The method according to claim 1, wherein
standard graphics hardware is used for generating representations of anisotropic properties.

13. The method according to claim 10, wherein
the reproduction of the radial distribution of the least one anisotropic property is generated on the surface of the sphere or polyhedron model by generating machine-readable image data,
wherein the machine-readable image data comprise a representation of the radial distribution of the at least one anisotropic property, and the machine-readable image data are imaged on the surface of the sphere or polyhedron model.

14. The method according to claim 1, wherein
that the machine-readable image data are at least one bitmap.

15. The method according to claim 14, wherein
the at least one bitmap is calculated on a plane.

16. The method according to claim 14, wherein
the at least one bitmap is calculated on a surface of the polyhedron.

17. The method according to claim 1, wherein
a function of a 3D graphics programming interface is used for mapping the machine-readable image data to the sphere or polyhedron surface.

18. An arrangement with at least one chip and/or processor, wherein the arrangement is arranged in such a way that a method for generating representations of anisotropic properties can be carried out in accordance with claim 1.

19. The arrangement according to claim 18, wherein
the arrangement further comprises a graphics card.

20. A computer program which enables a data processing device to carry out a method for generating representations of anisotropic properties in accordance with claim 1 after having been loaded into storage means of the data processing device.

21. A machine-readable storage medium on which a program is stored which enables a data processing device to carry out a method for generating representations of anisotropic properties in accordance with claim 1 after having been loaded into storage means of the data processing device.

22. A method in which a computer program according to claim 20 is downloaded from an electronic data network such as the Internet, on a data processing device connected to the data network
